(19) United States
(12) Patent Application Publication
(10) Pub. No.: US 2013/0254708 A1
(43) Pub. Date: Sep. 26, 2013

(54) Communication Room Management Systems

(71) Applicant: IPPLEX HOLDINGS CORPORATION, Santa Monica, CA (US)

(72) Inventor: Timothy C. Dorcey, Santa Monica, CA (US)

(73) Assignee: IPPLEX HOLDINGS CORPORATION, Santa Monica, CA (US)

(21) Appl. No.: 13/850,622

(22) Filed: Mar. 26, 2013

Related U.S. Application Data
(60) Provisional application No. 61/615,497, filed on Mar. 26, 2012.

(51) Int. Cl. H04L 12/58; G06F 3/0488

(52) U.S. Cl. CPC H04L 51/04; G06F 3/04886
USPC 715/788; 709/206; 715/781

(57) ABSTRACT

Multiuser communication systems are presented. The disclosed systems include a database of communication room objects and a communication room management server. The management server can instantiate one or more of the room objects as a persistent meeting room through which users can share multimedia content. The meeting room can remain persistent independent of user participation. The system can further include a display manager capable of configuring a display of a user device into multiple display regions where each display region can render one or more types of multimedia room content. A user can, with a single gesture, rearrange the display regions under governance of the display manager.

This application claims the benefit of priority to U.S. provisional application having Ser. No. 61/615497, filed Mar. 26, 2012. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is multiuser communication technologies.

### BACKGROUND

The following description includes information that may be useful in understanding the present invention. It is not an admission that any of the information provided herein is prior art or relevant to the presently claimed invention, or that any publication specifically or implicitly referenced is prior art.

As social networking communities grow, groups of users wishing to share multimedia data within the community are often required to share their media via an external service; Facebook™, Pintrest™, or Instagram™, just to name a few. However, such services lack sufficient control over how a group of users can interact with each other, or interact with the service.

Some effort has been put forth toward allowing users to create virtual meeting place where users sharing a common interest can exchange multimedia data. For example, Google® allows users to create hangouts for video chats, and Skype® allows for creating group calls in exchange for a fee. Although such applications are quite useful, they still have their deficiency. One major deficiency includes that the virtual meeting place lacks persistence beyond its created purpose. Once all the members of the meeting place leave, the meeting place no longer exists.

If users could create a virtual communication room that persists, then multiple users can engage with others in the room at any point in time to share multimedia data. The Applicants have appreciated that persistent meeting rooms give rise to many advantages to users even if users are non-active or join the room at a later time. For example, as the Applicants disclose below, users can subscribe to the room and can receive notifications when others join the room, or the room can include management rules that govern how multimedia data can be presented on each user's device.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for communication room management systems.

### SUMMARY OF THE INVENTION

The inventive subject matter provides apparatus, systems and methods in which a multiuser communication system can manage one or more persistent meeting rooms. One aspect of the inventive subject matter includes a system comprising a communication room database and communication room management server. The communication room database is configured to or programmed to store objects that represent meeting rooms, which allow multiple users to exchange multimedia data among users' devices. The communication room objects can further include a list of one or more users associated with the room along with associated management rules. The list of users can include current subscribers, active members, previous visitors, or other members affiliated with the persistent meeting room. The communication management server can be coupled with the room database and can be configured to or programmed to manage one or more persistent meeting rooms even when the persistent meeting room lacks active or registered users. The server can be configured to identify at least one communication room object in the database where the identified communication room object could be a previously created room or could be a template from which a meeting room can be instantiated. Once a selected room object is ready the server can instantiate a persistent meeting room object according to the available management rules. The server obtains room visitor information (e.g., name, device ID, email address, phone number, accounts, etc.) that represents possible users or their respective devices. Further, the server uses the visitor information to populate the persistent meeting room's user lists. During the life time of the persistent meeting room, the management server can monitor the status of one or more members from the room's user lists. Should the member state satisfy rules within the management rules, the server can construct one or more room messages (e.g., user left, user joined, user join request, list of users, configuration instructions, etc.). The room messages can be sent to one or more user devices thereby enabling the devices to interact with the persistent meeting room according the information within the room message. Thus, the room message can relate to the room in general, specific users, specific user devices, or other entity associated with the room.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic overview of a multiuser communication system capable of providing access to persistent meeting rooms.

FIG. 2A illustrates a multimedia user interface of a persistent meeting room.

FIG. 2B illustrates the user interface of FIG. 2A in response to a single user gesture input causing display regions to change dimensions.

FIG. 2C illustrates the user interface of FIG. 2A in response to a second single user gesture input causing display regions to change dimensions.

FIG. 3A illustrates another multimedia user interface of a persistent meeting room.

FIG. 3B illustrates the user interface of FIG. 3A during single user gesture input causing display regions to change position and dimensions.

FIG. 3C illustrates the user interface of FIG. 3A in response to a completed single user gesture input causing display regions to change position and dimensions.

### DETAILED DESCRIPTION

Throughout the following discussion, numerous references will be made regarding servers, services, interfaces, portals, databases, platforms, engines, or other systems formed from computing devices. It should be appreciated that the use of such terms is deemed to represent one or more computing devices having at least one processor configured or programmed to execute software instructions stored on a computer readable tangible, non-transitory medium. For example, a server can include one or more computers operating as a web server, database server, or other type of computer server in a manner to fulfill described roles, responsibilities, or functions. One should appreciate that the disclosed systems generate signals capable of causing user devices to interact with each other via a communication room. For example, each device can send or receive multimedia data from other user devices that are members of the communication room, or can independently control how the multimedia data is displaced. Such capabilities can be governed by communication room management rules.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document the terms “coupled to” and “coupled with” are used euphemistically to mean “communicatively coupled with” where two or more networked devices are able to communicate over a network.

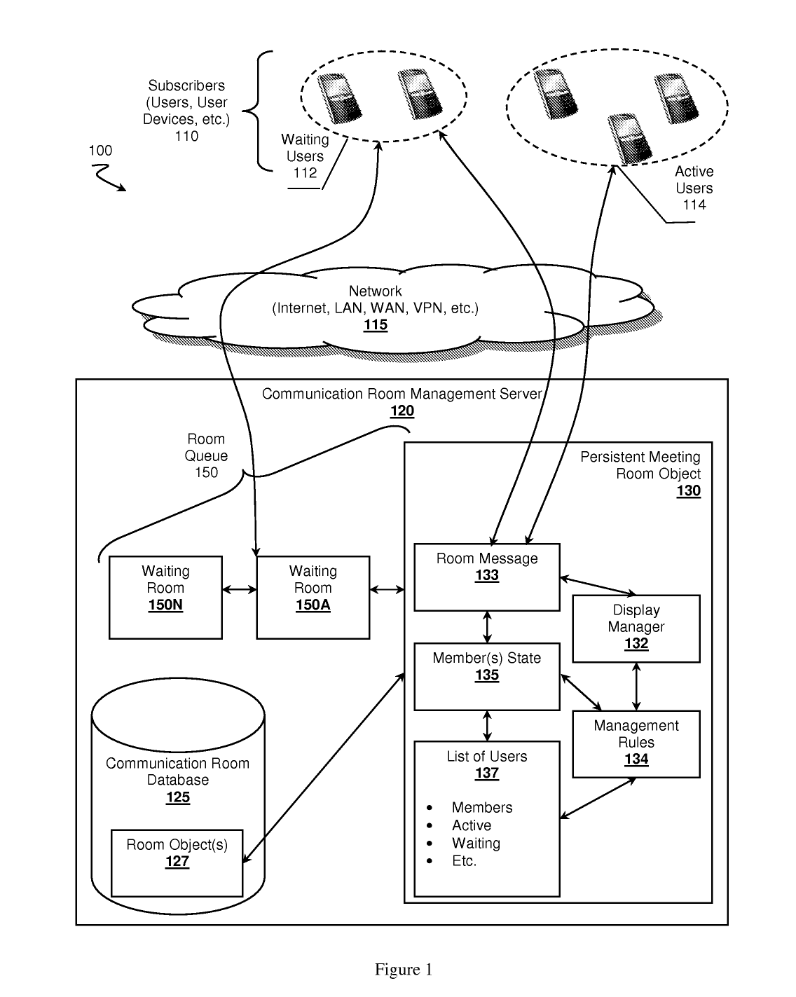

FIG. 1 illustrates an overview of multiuser communication system 100. System 100 allows one or more of users 110 to interact with each other via a communication room represented by persistent meeting room object 130. Users 110 are able to exchange multimedia data that can include nearly any type of data modality (e.g., audio data, text data, video data, image data, kinesthetic data, etc.) with each other via one or more communication channels constructed within a multiuser meeting room represented by persistent meeting room object 130.

Users 110 can include a broad spectrum of user types. In some scenarios, users 110 can include active users 114 that are currently active within the meeting room as represented by persistent meeting room object 130. Should there exist room restriction criteria, possibly defined within room management rules 134, other users 110 might be restricted from fully participating within the meeting room. Restrictions could include limiting users based on one or more of the following factors: bandwidth limitations, latency among user devices, latency budgets, defined preferences, authentication or authorization requirements, mutual exclusion rules (e.g., user A cannot be in the room at the same time as user B, time of day, etc.), or other factors. Users that are waiting for access to persistent meeting room object 130 are represented by waiting users 112. One should appreciate that users 110 can include other types of users including deactivated users, registered users, banned users, while listed users, idle users, unregistered yet affiliated users (e.g., friends of known users), user groups, or other types of users.

Users 110 interact with persistent meeting room object 130 over network 115. Network 115 can include various forms of networks including the Internet, LANs, WANs, VPNs, cellular networks, peer-to-peer network, mesh networks, or other forms of networks; wired or wireless.

Persistent meeting room object 130 exists within system 100 as supported by communication room database 125 and communication room management server 120. Communication room database 125 represents a computing device, possibly the same computing device operating as communication room management server 120, configured to or programmed to store communication room objects 127. Communication room objects 127 can represent templates by which meeting rooms are instantiated or can include already instantiated meeting rooms stored for current or future use. One should appreciate that communication room objects 127 are considered to represent meeting rooms for users 110 where communication room objects 127 can include one or more attributes describing the nature of the corresponding meeting rooms. Example attributes can include a room identifier (e.g., name, GUID, UUID, URL, address, top level domains, etc.), room management rules represented by management rules 134, room descriptors (e.g., interests of users, nature of data to be exchanged, etc.), room relationships (e.g., relationships to other rooms, relationships among users, etc.), room links or pointers allowing for construction of linked rooms (see room queue 150), or other attributes.

Communication room management server 120 is a computing device configured to host one or more meeting rooms. For example, management server 120 could comprise an HTTP server capable of offering access to meeting rooms as a web service. In other embodiments server 120 could include a virtualized infrastructure in a cloud-based environment operating as a Platform-as-a-Service (PaaS), Infrastructure-as-a-Service (IaaS), or Software-as-a-Service (SaaS). Further management server 120 could also include a mobile device (e.g., cell phone, tablet, game console, etc.) configured to fulfill roles or responsibilities of the management server 120. In some embodiments management server 120 could even include a user device, possibly operating within a peer-to-peer environment.

Communication room management server 120 can be programmed to identify a communication room object 127 from communication room database 125. In some embodiments, one or more of users 110 can access management server 120 via a management interface (e.g., web page; not shown) to request a meeting room. In response to the request, management server 120 can construct a query having criteria outlining room requirements or optional features and submit the query to room database 125. In response to the query, room database 125 can return one or more communication room objects 127 that can then be used to instantiate one or more persistent meeting room objects 130. Thus, one could consider communication room objects 127 as a template or class, from which a persistent meeting room can be instantiated. Alternatively, communication room objects 127 can represent existing or previously instantiated meeting rooms. It should be noted that communication room objects 127 can further include room management rules 134 that can govern the operation of a corresponding instantiated persistent meeting room.

Communication room management server 120 can be further programmed to obtain visitor information associated with a plurality of visitors (e.g., users 110, waiting users 112, active users 114, etc.) related to the obtained communication room object 127. The visitor information can include users information (e.g., user name, avatars, phone numbers, email address, account information, etc.), user device information (e.g., IP address, phone number, model type, display capability, etc.), or other user related information. The visitor information can be obtained directly from users upon registration or from other sources, possibly social networking sites (e.g., Facebook, LinkedIn, etc.).

When communication room management server 120 has sufficient parameters (e.g., communication room object 127, visitor information, room attributes, room management rules 134, etc.), server 120 can instantiate persistent meeting room object 130 according to management rules 134 and based on the identified corresponding communication room object 127 from database 125. One should appreciate that persistent meeting room object 130 represents a multiuser meeting room that can exist regardless of the state of its member users. Thus, persistent meeting room object 130 can remain active and available even when no users are active.

Communication room management server 120 uses the visitor or user information to populate list of user 137 of persistent meeting room object 130. List of users 137 can include users or their respective devices that are associated with the room including subscribers, waiting users 112, active users 114, or other types of users. In some embodiments, list of users 137 includes previous users that have visited the room or have had previous interactions with persistent meeting room object 130. List of users 137 can be sorted or ranked according to any desirable criteria including recency of visit to persistent meeting room object 130, number of posts, relationships among users, or other factors.

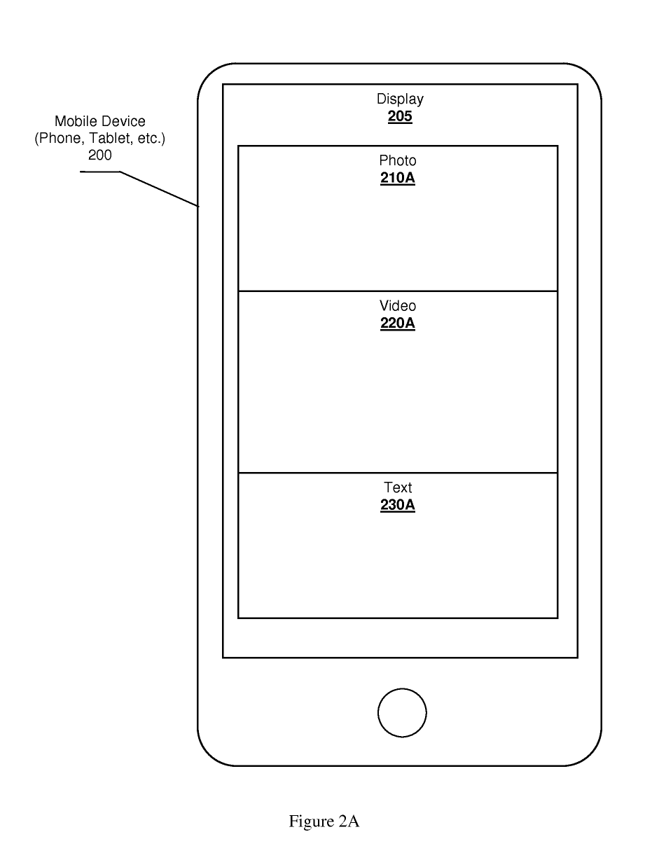

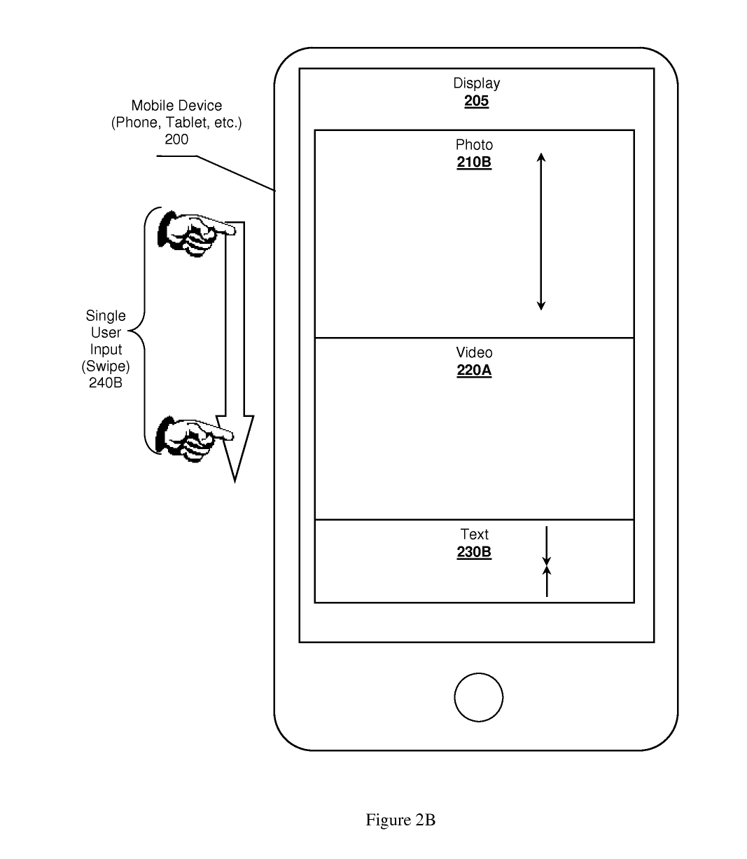

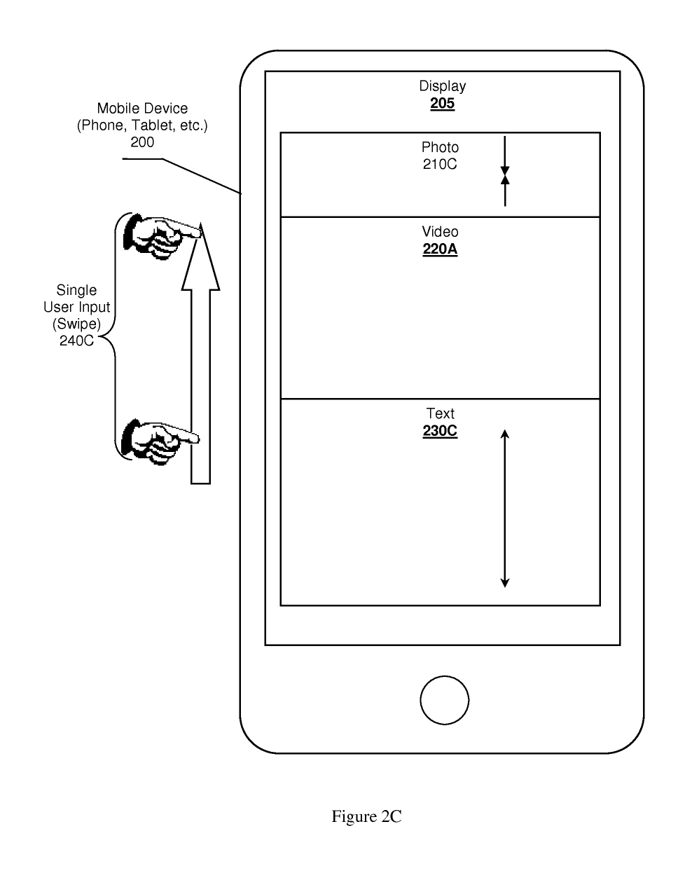

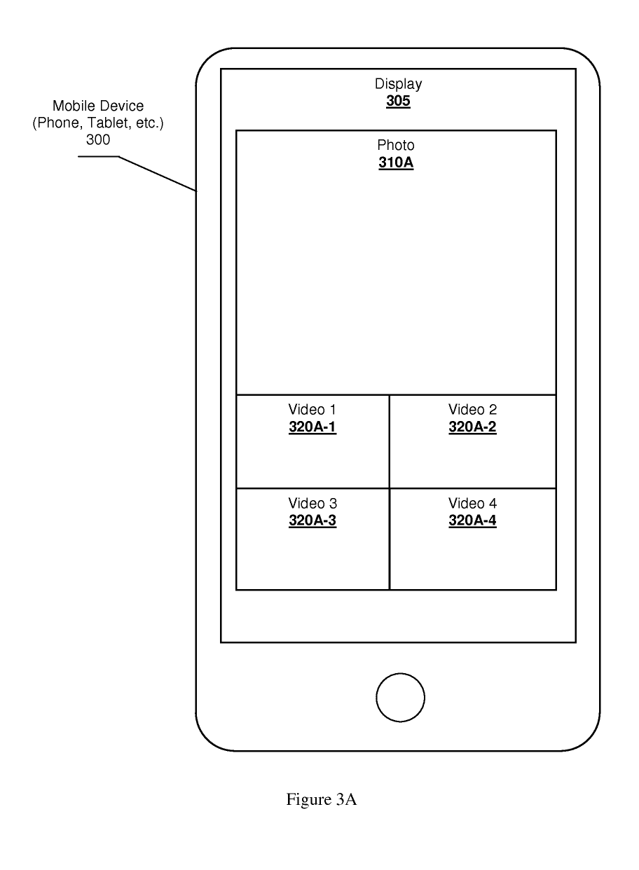

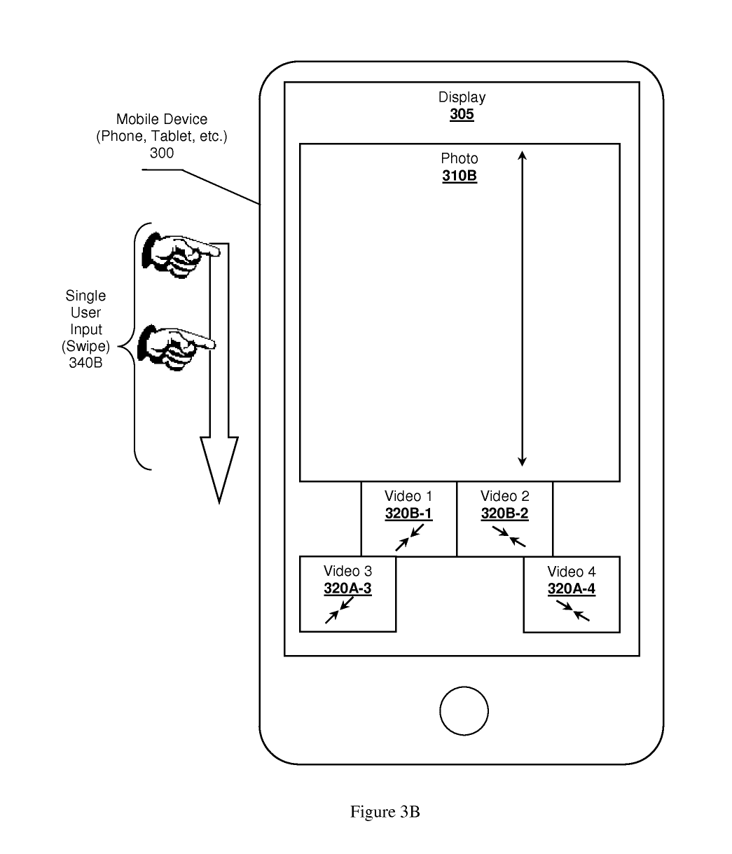

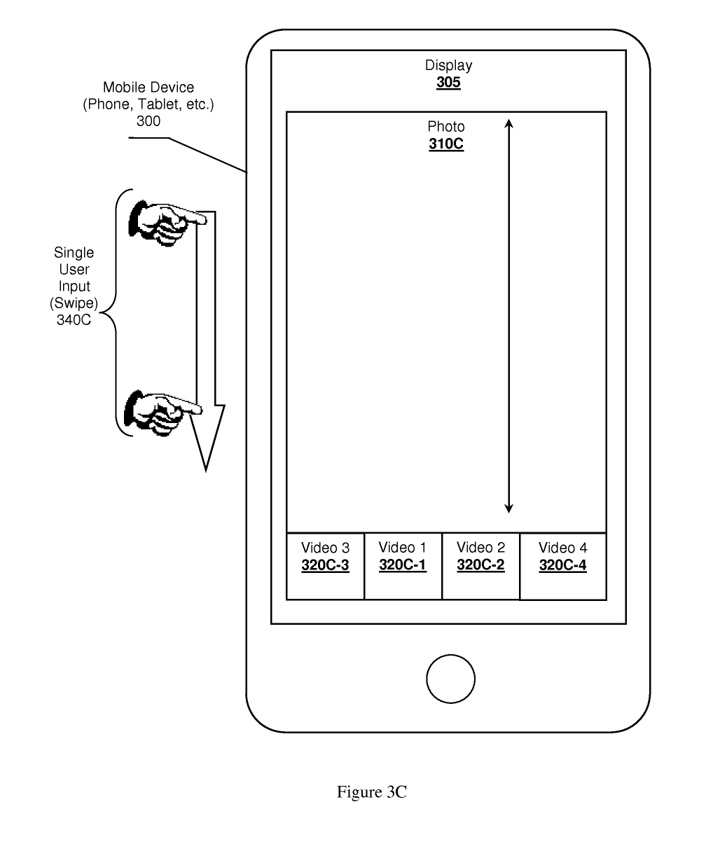

Once persistent meeting room object 130 has been instantiated and is ready for use, one or more of users 110 can interact with the room or with each other according to management rule 134. Management rules 134 provide instructions to communication room management server 120 on how to govern the behavior of the meeting room. Management rules 134 can include display rules (see discussion with respect to FIGS. 2A-2C, and 3A-3C), media data routing rules, notification rules, restrictions on users, restrictions on content, or other rules. Thus, communication room management server 120 allows user devices associated with the list of users 137 to exchange multimedia content amongst each other according to management rules 134. For example, outbound notifications to devices can be carried by Apple Push Notification Service, over TCP. Further, server 120 can send “SMS invites” to transmit a room address to other devices, possibly via phone number. However, one should appreciate communication room management server 120 can leverage any suitable communication technology. In some embodiments, a user device operating as server 120 can simply send an SMS invite to another user device. In such an embodiment, a user device can access an SMS user interface provided by the device's operating system and pre-populate at least some content of the message. Other forms of communication by which user devices can exchange multimedia include through email exchange (e.g., SMTP), social networks (e.g., Twitter, Facebook, etc.), MMS services, or other technologies.

Communication room management server 120 can observe interactions among users and with persistent meeting room object 130. Based on the observations, server 120 can determine one or more of member state 135 based on the activity of the members within list of users 137. Member state 135 could represent a state of a specific user, a group of users (e.g., waiting users 112, friends, active users 114, etc.), or other user group. Member state 135 can cover a broad spectrum of possible states as outlined in management rules 134. States could include simple user states including active, non-active, waiting, subscribed, or other state reflecting a user's circumstance with respect to persistent meeting room object 130. More complex states can be defined as a function of user attributes possibly including demographics, psychographics, content exchanged, number of actions taken, or other parameters.

One should appreciate that persistent meeting room object 130 can be considered a “room” that operate like a telephone conference bridge or Internet “chat room”, expect having persistence over time. When a user joins a room, they enter into multimedia communications with all other members of the room. If a user chooses to monitor a room, a push notification alert can be sent to their user device as a device message whenever someone joins the room. Responding to the notification room message can cause the user to join the room. In that sense it behaves like a traditional telephone call, except rather than associating a phone number with a single individual, users subscribe to as many numbers as they wish. It is like a telephone conference bridge that calls out to a list of numbers whenever anyone calls in. Users may be allowed to subscribe themselves to a “number”, or it may be controlled administratively.

Based on room management rules 134, room management server 120 accordingly constructs room message 133 based on member state 135. For example, management rules 134 can include one or more notification, alert, or other message criteria defined as a function of the properties of a member state attribute space. When one or more of member state 135 satisfies the criteria, a corresponding message 133 can be constructed.

Once constructed, management server 120 can enable one or more of the user devices to interact with persistent meeting room object 130 according to the content of room message 133. In some embodiments, room message 133 represents only an informational or room notification message. Consider a scenario where list of users 137 includes previous room visitors. Each of persistent meeting room object 130 can maintain a list of all previous visitors, sorted by recency of visit, or displaying the date/time of their last visit. List of users 137 can be made available for inspection by authorized users who have access to the room. Such information is considered valuable because it can provide insight into who may be likely to join a user if the user joins the room. For example, if someone a user intended to meet left moments ago, they may still be available and will return upon receiving room message 133 in the form of a join request message. Room message 133 could also include a user joined message as a notification to others when a person has joined the meeting room. Alternatively, if the room is frequented by many people, it gives room message 133 could comprise list of users 137 including general information about what kind of people frequent the room. Thus, room message 133 could include a sorted or sort-able list of users 137.

Room message 133 can also include more complex messages, possibly including instructions for the user devices. For example, room message 133 could include a room configuration message that informs the user device of the features, capabilities, APIs, or other configurations of persistent meeting room object 130. Further, room message 133 could include specific user device configuration messages that provide specific instructions to a specific user device, or class of user device. The user device configuration messages could instruct the device to render multimedia room content according to specific content features or device features.

In some embodiments, persistent meeting room objects 130 have a limited capacity due to technical limitations of bandwidth, processing power, screen display area, social limitations on an ability to maintain productive conversation, or other limitations. When an instantiated meeting room is full, one or more waiting room 150A through 150N can be automatically created for additional visitors, waiting users 112 for example. If waiting room 150A becomes full, a second waiting room 150N could be created, and so on, for as many as are required to accommodate all visitors. Whenever someone leaves persistent meeting room object 130, the person in the next room who has been waiting the longest can be promoted to the empty slot. This opens a spot in their waiting room for the person who has been waiting in the next room the longest, and so on. One person moves forward from each room behind the one that was initially vacated. Likewise, some users 110 may have special privileges to enter a room that is full. In this case, the user who most recently joined that room is demoted to the next waiting room 150A behind them. This in turn bumps a user from that room in to the next, and so on. It is as if all visitors are ordered in a single room queue 150 that is subdivided into contiguous conversation circles. As the queue moves forward or backward, users cross the line from one circle to the next. Thus the inventive subject matter is considered to include construction of room queue 150 of instantiated communication room objects that could include persistent meeting room object 130. One should appreciate that persistent meeting room object 130 does not necessarily have to be the head of the queue, but could be an intermediary waiting room

Some embodiments comprises display manager 132 configured to or programmed to control multiple display regions on one or more user devices; collectively or individually. As illustrated, display manager 132 can be part of communication room management server 120, part of instantiated persistent meeting room object 130, an application on the user device, or other element of system 100. Further, display manager 132 can influence the behavior or presentation of room message 133 under governance of room management rules 134. One should appreciate that significance of the disclosed multimedia display management system. Display manager 132 can be considered as providing “modes” of use of content along a continuous spectrum of presentation or use. Such an approach is considered advantageous because a user can easily move from one display representation to another via a fluid change rather than switching between discrete modes. Thus, the user experiences fluid, intuitive intermediary changes from one mode to mode where at any point during the switching process all display regions remain active, functional, or accessible.

As illustrated in FIG. 2A, the display manager preferably controls one or more display regions for multimedia content from the instantiated meeting room. For the sake of discussion, the reader can assume that the display manager is local to device 200; a cell phone app for example capable of interacting with persistent meeting rooms. In the example shown display 205 represents a multimedia display user interface capable of simultaneously displaying a photo content in photo region 210A, multiple videos in video region 210B or text chat in text region 210C on a relatively small mobile device touch sensitive screen.

FIG. 2B illustrates an effect on the multimedia user interface caused by single user input signal 240B generated from a touch sensitive display sensor. In the example shown single user input 240B comprises a single stroke gesture, a swipe, which allows the user to move seamlessly and intuitively between different configurations of display regions. In response to the gesture or swipe, the display manager adjust dimensions of multiple display regions (i.e., photo region 210B and text region 230B). Further, as shown, a different display region (i.e., video region 220A) retains its dimensions while the other display regions dimensions are adjusted.

As illustrated in FIG. 2B, swiping down enlarges photo region 210B while shrinking the text region 230B. Alternately, as illustrated in FIG. 2C single user input 240C comprises a swipe up which causes text region 230C to enlarge while shrinking photo region 210C. In both cases, the dimensions of video region 220A remains unchanged, at least until either the photo region 210C or text region 230C are entirely gone or removed.

In embodiments, were one type of display region dominates a display after user interaction, the display regions can change configuration further by changing dimensions and position of the regions in a controlled manager according the display rules within the management rules. For example, FIG. 3A illustrates device 300 having display 305 where a user has configured display 305 to present only photo content in photo region 310A and video content in video regions 320A-1 through 320A-4. The display manager can be configured to present such an arrangement upon elimination of the text display region from FIG. 2B. When the video region 220A of FIG. 2B has reached the bottom margin of display 205, video display region 220A can separate into multiple video display regions 320A-1, 320A-2, 320A-3, and 320A-4 (collectively referred to as video regions 320A) as illustrated and according to management rules governing the display manager.

As illustrated, video regions 320A can accommodate up to 4 individual videos, although any practical number is contemplated, each having a fixed at 4:3 aspect ratio. All aspect ratios are contemplated.

FIG. 3B illustrates the behavior of display 305 under direction of single user input 340B, which represents a swipe gesture that is in progress. As the height of the display area for videos shrinks, the video regions 320A-1, 320A-2, 320A-3, and 320A-4 shrink vertically and horizontally to video regions 320B-1, 320B-2, 320B-3, and 320B-4, respectively, while preserving a desired aspect ratio, 4:3 aspect ratio for example. One should appreciate that video regions 320B represent an intermediary step during the gesture. As illustrated, video regions 320B-1 and 320B-2 remain fixed at a center line of display 305, while video regions 320B-3 and 320B-4 remain fixed at their respective left and right margins of display 305. Such an approach, allows video regions 320B-1 to 320-4 to slide neatly into a 1×4 configuration as illustrated in FIG. 3C with respect to video regions 320C-3, 320C-1, 320C-2, and 320C-4 upon completion of single user input 340C. In the case where there are two or fewer display regions, regions 320A-3 and 320A-4 are simply missing, so the photo region 310A, 310B, or 310C can become larger before any shrinking of video regions becomes necessary.

The display manager can also be configured to provide similar behavior if the user has swiped upward to increase the size of a bottom display area (e.g., text region 230C). In this case, scrolling continues until display 305 is occupied entirely by the text area, but for a 1×4 strip of video or photo regions across the top. Hence, with a single continuous swiping motion the user can move smoothly from a 1×4 strip of half-size videos, or other content, at the bottom margin with a photo above, to a 1×4 strip of half-size video at the top margin, with text below. Although video, photo, and text are used in the example, one should appreciate the technique can be applied to other types of multimedia content. Further, each display region can comprise content from the instantiated communication room to which the user or the user device belongs.

While the continuous range of motion makes the operation feel intuitive, certain stopping points can produce configurations that are consider more useful in practice. If the user scrolling action stops near one of these natural stopping points, the scrolling can automatically snap to a defined snap point position as defined by the display manager. Also, certain events may trigger the disclosed automatic scrolling action. For example, if a text message arrives, it can automatically scroll as necessary to make that new message visible.

As a further enhancement, content can be selected to appear in any display region. For example, with respect to FIG. 3C, the content of video region 320C-2 could be swapped with the content in photo region 310C. In particular, if any of the videos in the 2×2 grid is tapped, an up arrow button or icon could appear overlaid on the region to indicate that the content of the region can be swapped or moved. Tapping the arrow swaps that video into the large display region.

It is also contemplated that display 305 could also include management of a toolbar. The toolbar could appear at the bottom of the screen, but may be pushed off the screen by the upward scrolling action, allow more room for photo, videos, or other multimedia content. Further, for text input, a virtual keyboard may appear at the bottom of the screen, automatically pushing up the bottom margin of the text display area.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A multiuser communication system comprising:
a communication room database programmed to store communication room objects where each communication room object represents a meeting room and comprises
a list of users and room management rules; and
a communication room management server coupled with the communication room database and programmed to:
identify a communication room object from the communication room database;
obtain visitor information associated with plurality of visitors related to the communication room object;
instantiate a persistent meeting room object from the communication object according to management rules for the identified communication room object;
populate the list of users of the persistent meeting room object as a function of the visitor information;
allow user devices associated with the list of users to exchange multimedia content amongst each other according to the management rules;
determine a member state based on activity of members within the list of users;
construct a room message according to the management rules based on the member state; and
enable a user device to interact with the persistent meeting room object according to the room message.

2. The system of claim 1, wherein the multimedia content includes at least one of the following types of data: audio data, text data, video data, image data, and kinesthetic data.

3. The system of claim 1, further comprising a display manager configured to control multiple display regions on the user device.

4. The system of claim 3, wherein a first display region of the multiple display regions is configured to display a first type of media from the multimedia content and a second display region of the multiple display regions is configured to display a second type of media from the multimedia content.

5. The system of claim 3, wherein the display manager is configured to adjust dimensions of the multiple display regions according in response to a single user input on the user device.

6. The system of claim 5, wherein the user input includes a signal from a touch sensitive display sensor.

7. The system of claim 3, wherein the display manager is configured to retain dimensions of at least one display region while adjusting dimensions of at least two display regions in response to the user input according to the management rules.

8. The system of claim 3, wherein the display manager is configured to adjust position and dimensions of at least some of the display regions in response to the user input.

9. The system of claim 1, wherein the room message comprises a room configuration message.

10. The system of claim 1, wherein the room message comprises a user device configuration message.

11. The system of claim 1, wherein the room message comprises a room notification message.

12. The system of claim 11, wherein the room notification message includes a join request message.

13. The system of claim 11, wherein the room notification message includes a user joined message.

14. The system of claim 1, wherein the list of users comprises a list of subscribers.

15. The system of claim 14, wherein the list of users comprises previous users.

16. The system of claim 14, wherein the communication room management server is further configured to sort the list of users.

17. The system of claim 16, wherein the list of users is sorted according to recency of visit to the persistent meeting room object.

18. The system of claim 16, wherein room message includes the sorted list of users.

19. The system of claim 1, wherein the persistent meeting room comprises a room identifier.

20. The system of claim 1, wherein the communication room management server is further configured to construct a room queue of instantiated communication room objects that includes the persistent meeting room object.

21. The system of claim 20, wherein the persistent meeting room object comprises a waiting room.

22. The system of claim 1, wherein a mobile device comprises the communication room management server.

23. The system of claim 1, wherein the communication room management server includes a web-based service.
